(19) United States
(12) Patent Application Publication
(10) Pub. No.: US 2020/0067798 A1
(43) Pub. Date: Feb. 27, 2020

(54) METHOD AND SYSTEM TO COMPUTE AUTOMATION OPPORTUNITIES FROM CHANGE AND SERVICE TICKETS

(71) Applicant: International Business Machines Corporation, Armonk, NY (US)

(72) Inventors: Anup Kalia, Elmsford, NY (US); Rohit Madhukar Khandekar, Jersey City, NJ (US); Jin Xiao, Ossining, NY (US); Raghav Batta, Ossining, NY (US); Maja Vukovic, New York, NY (US); Naga A. Ayachitula, Elmsford, NY (US)

(21) Appl. No.: 16/107,607

(22) Filed: Aug. 21, 2018

(51) Int. Cl. H04L 12/24; G06F 17/30; G06Q 10/00; G06F 15/18

(52) U.S. Cl. CPC H04L 41/5074; G06F 17/30734; G06F 15/18; G06Q 10/20; G06F 17/30958

(57) ABSTRACT

One or more embodiments relate to a method and system to compute automation opportunities from change and service tickets. A system, comprises a memory that stores computer executable components; a processor that executes computer executable components stored in the memory, wherein the computer executable components comprise: an ingestion component that receives data and determines automation opportunities for a service catalog; a categorization component that determines domain specific clusters and categories of service or change tickets; a graphing component that generates an action specific semantic graph of service or change ticket offerings; and a mapping component that maps a valid action to a cataloged service or change ticket.

### TECHNICAL FIELD

The subject disclosure relates generally to a method and system that captures compiled change and service ticket data and processes that data utilizing various unsupervised approaches to learn and generate domain knowledge that can map categorized tickets to one or more offerings in a service catalog.

### SUMMARY

The following presents a summary to provide a basic understanding of one or more embodiments of the invention. This summary is not intended to identify key or critical elements, delineate scope of particular embodiments or scope of claims. Its sole purpose is to present concepts in a simplified form as a prelude to the more detailed description that is presented later. In one or more embodiments described herein, systems, computer-implemented methods, apparatus and/or computer program products that facilitate learned mapping of categorized tickets to offerings in service catalogs (e.g., such as SSD, ICD, QS, SNOW QS).

In some embodiments, a system comprises: a memory that stores computer executable components; and a processor that executes computer executable components stored in the memory. The computer executable components comprise: an ingestion component that receives service or change tickets and determines automation opportunities for a service catalog; a categorization component that determines domain specific clusters and categories of the service or change tickets; a graphing component that generates an action specific semantic graph of service or change ticket offerings; and a mapping component that maps a valid action to a cataloged service or change ticket.

One non-limiting advantage of the embodiment is to continuously analyze new incoming tickets and map them to offerings in a consistent and reliable manner.

In some embodiments, the categorization component employs multiple approaches to generate clusters that can be assigned to certain categories. An advantage of the embodiment can comprise compiling deep and wide data clusters. Another advantage is the ability to learn new content and enhance domain knowledge to increase addressable types of change and service tickets.

In some embodiments, a computer-implemented method, comprises: receiving, by a device operatively coupled to a processor, service or change tickets and determining automation opportunities for a service catalog; determining, by the device, domain specific clusters and categories of the service or change tickets; generating, by the device, an action specific semantic graph of service or change ticket offerings; and mapping, by the device, a valid action to a cataloged service or change ticket. An advantage of the embodiment can comprise utilizing a consistent methodology to produce reliable real-life data clusters and semantic connections to produce highly efficient and scalable domain knowledge centers.

### DESCRIPTION OF THE DRAWINGS

FIG. 1 illustrates a block diagram of an example system implemented that can access data and process that data using variable computing components depicted in accordance with one or more embodiments described herein.

FIG. 2 illustrates the method and data flow of the embodiments along with various connections and feedback loops.

FIG. 3 illustrates action specific Semantic graphs and an example of relationships within the graphs based on the embodiments.

FIG. 4 illustrates the concept of knowledge transfer between domains or 2 sets of data.

FIG. 5 illustrates the mapping of actions to offerings concept in accordance with one or more embodiments described herein.

FIG. 6 illustrates the method functional architecture involved in accordance with one or more embodiments described herein.

FIG. 7 illustrates the flowchart of the computing automation opportunities from change and service tickets in accordance with one or more embodiments described herein.

FIG. 8 is a schematic diagram of an example operating environment in accordance with one or more implementations described herein.

### DETAILED DESCRIPTION

The following detailed description is merely illustrative and is not intended to limit embodiments and/or application or uses of embodiments. Furthermore, there is no intention to be bound by any expressed or implied information presented in the preceding Summary section, or in the Detailed Description section. One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident; however, in various cases, that the one or more embodiments can be practiced without these specific details.

The embodiments within focus on computing automation opportunities in change and service tickets which refers to numbers of tickets that can be mapped with one or more offerings in a service catalog. A service catalog refers to a taxonomy of offerings and is often proposed by a company or an organization to deal with their IT service management. By computing automation opportunities, the embodiments represent an attempt to understand what type of different actions can be discovered from each specific ticket.

Within IT systems, many problems or requests (e.g., change and service tickets) can occur (such as network slowdowns, database reboots, OS functionality, etc.) that are very time consuming to resolve as information is passed back and forth from human to human Many of these items are repetitive in nature and are addressed by service providers on a regular basis. One or more embodiments provides opportunity to categorize various problem and request types and improve routing of tickets for fast resolution and retainment of learned data that can be utilized in future enhancement.

An implementation follows an unsupervised approach in which once an action is discovered an opportunity is computed by comparing to other actions present in a specific catalog. Each catalog presents different type of change actions based on perspective of one or more particular domains. An advantage is that one or more embodiments capture data from the real world and discover actions that map to catalog actions. Accordingly, computing automation opportunities are facilitated.

One or more embodiments employ the following approaches: Frequency based approaches (frequency of verbs and nouns extracted from text descriptions), Topic Modeling approaches (Latent Dirichlet Allocation, Non-Negative Matrix Factorization) and Deep Learning approaches (Auto-encoders+K-means). The frequency-based approach determines frequency of verbs and nouns associated with a subset of service or change tickets. The topic modeling approach utilizes Latent Dirichlet allocation and non-negative matrix factorization to analyze a subset of the service or change tickets by generating clusters. The deep learning approach is used to analyze a subset of the service or change tickets by generating clusters. Examples of clusters produced by various approaches are: (LDA Approach: Topic 1: (software, ip, install, procure), (Topic 2: decom, servers, patch, state). (NMF Approach: Topic 1: (activate, jack, colorado, network), Topic 2: (application, install, issue, access), Topic 3: (install, additional, software, ip). (Autoencoders+K-means Approach: Cluster 1: (jack, imac, activate), Cluster 2: (kpim, share, create), Cluster 3: (provision, server, windows).

The clusters (e.g., a collection of verbs and nouns extracted from short text descriptions) are interrogated by capturing relevant verb and noun pairs by analyzing deep parsed graphs generated for each ticket. The valid verb and noun pairs represent valid actions. Embodiment(s) then apply a transfer learning technique to create knowledge that accounts for a substantial corpus of ITSM terminologies and category-specific variances. The categories created from clusters can vary into different types. For example, one category can be “Hardware” by focusing on nouns such as mobile, phone, hardware, printer, inventory, laptop, workstation and verbs such as procure, configure, update, map, remap, replace, assign, pickup, install. Another category can be “Software” by focusing on nouns such as application, SW, account, package and verbs such as request, activate, install and change. Various embodiments can generate multiple categories to support variations of tickets that are analyzed. At such point, a valid action is mapped to an offering to compute coverage for each offering in service catalogs such as SSD, ICD, SNOW.

A novel aspect of these embodiments is that many more actions can be utilized than in conventional approaches. These embodiments using an unsupervised approach can discover thousands of actions versus only 30-60 actions as by current state of the art. These embodiments can also create new categories and identify variations of standard IT actions which are not covered in the service catalogs directly. Another novel aspect is the embodiments provide an architecture to run and fine tune approach(es) dynamically.

Various embodiments can provide a scalable approach for identifying requests to actions. The embodiments focus on generating transferrable knowledge that can be shared and utilized across clients and request types. This action-noun driven approach can be extended to support non-English languages and can accommodate a diverse set of automation catalogs with architectures based on action target parameters. Various embodiments utilize both semantic relations of the offering descriptions and keywords to facilitate pattern-based matching.

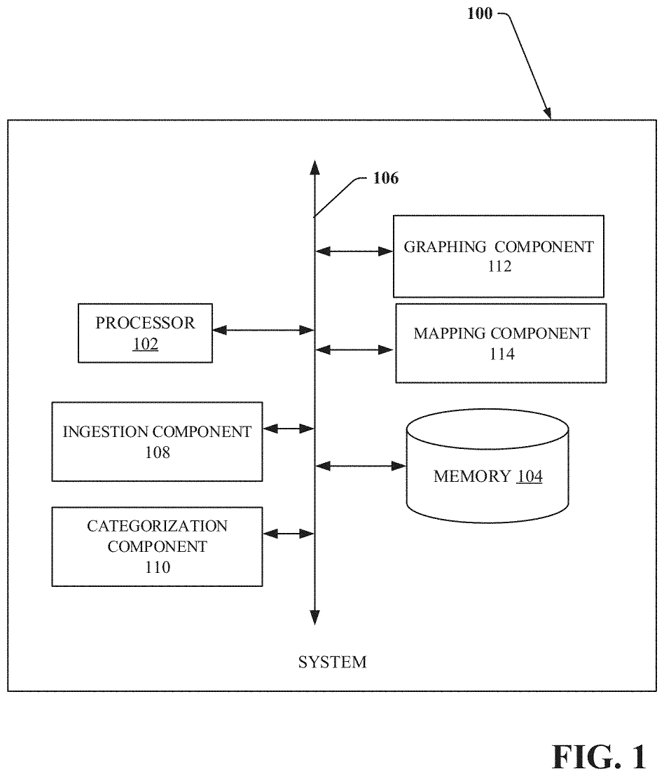

FIG. 1 illustrates a block diagram of an example system 100 that can access data and process that data using variable computing components depicted in accordance with one or more embodiments described herein. The system 100 can facilitate a process of assessing and identifying a large amount of various forms of data, and using machine learning, training a neural network or other type of model. The system 100 can also generate predictive recommendations to an individual level resulting in a context in accordance with one or more embodiments described herein. Aspects of systems (e.g., system 100 and the like), apparatuses or processes explained in this disclosure can constitute machine-executable component(s) embodied within machine(s), e.g., embodied in one or more computer readable mediums (or media) associated with one or more machines. Such component(s), when executed by the one or more machines, e.g., computer(s), computing device(s), virtual machine(s), etc. can cause the machine(s) to perform the operations described. Repetitive description of like elements employed in one or more embodiments described herein is omitted for sake of brevity.

System 100 can optionally include a server device, one or more networks and one or more devices (not shown). The system 100 can also include or otherwise be associated with at least one processor 102 that executes computer executable components stored in memory 104. The system 100 can further include a system bus 106 that can couple various components including, but not limited to, an ingestion component 108, a categorization component 110, a graphing component 112, and a mapping component 114. The system 100 can be any suitable computing device or set of computing devices that can be communicatively coupled to devices, non-limiting examples of which can include, but are not limited to, a server computer, a computer, a mobile computer, a mainframe computer, an automated testing system, a network storage device, a communication device, a web server device, a network switching device, a network routing device, a gateway device, a network hub device, a network bridge device, a control system, or any other suitable computing device. A device can be any device that can communicate information with the system 100 and/or any other suitable device that can employ information provided by system 100. It is to be appreciated that system 100, components, models or devices can be equipped with communication components (not shown) that enable communication between the system, components, models, devices, etc. over one or more networks.

In accordance with the system 100, a memory 104 can store computer executable components executable by the processor 102. The ingestion component 108 can receive service or change tickets and determine automation opportunities for a service catalog. The categorization component 110 can determine domain specific clusters and categories of the service or change tickets. The categorization component employs a frequency-based approach that determines frequency of verbs and nouns associated with a subset of the service or change tickets. This frequency-based approach finds relevant verb and noun pairs by analyzing deep parsed graphs generated for each ticket, and wherein the valid verb and noun pairs represent valid actions. The categorization component can also employ a topic modeling approach that utilizes Latent Dirichlet allocation and non-negative matrix factorization to analyze a subset of the service or change tickets by generating clusters. Within these embodiments, the categorization component may also employ deep learning to analyze a subset of the service or change tickets by generating clusters.

The graphing component 112 generates an action specific semantic graph of service or change ticket offerings, this component also matches a semantic graph structure of a request to an offering graph based on features, wherein the features include: distance, weight and type. The mapping component 114 maps a valid action to a cataloged service or change ticket by utilizing semantic relations of offering descriptions and keywords to facilitate pattern-based matching.

The various components of system 100 can be connected either directly or via one or more networks. Such networks can include wired and wireless networks, including, but not limited to, a cellular network, a wide area network (WAN) (e.g., the Internet), or a local area network (LAN), non-limiting examples of which include cellular, WAN, wireless fidelity (Wi-Fi), Wi-Max, WLAN, radio communication, microwave communication, satellite communication, optical communication, sonic communication, or any other suitable communication technology. Moreover, the aforementioned systems and/or devices have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components can be combined into a single component providing aggregate functionality. The components can also interact with one or more other components not specifically described herein for the sake of brevity, but known by those of skill in the art.

The subject computer processing systems, methods apparatuses and/or computer program products can be employed to solve new problems that arise through advancements in technology, computer networks, the Internet and the like.

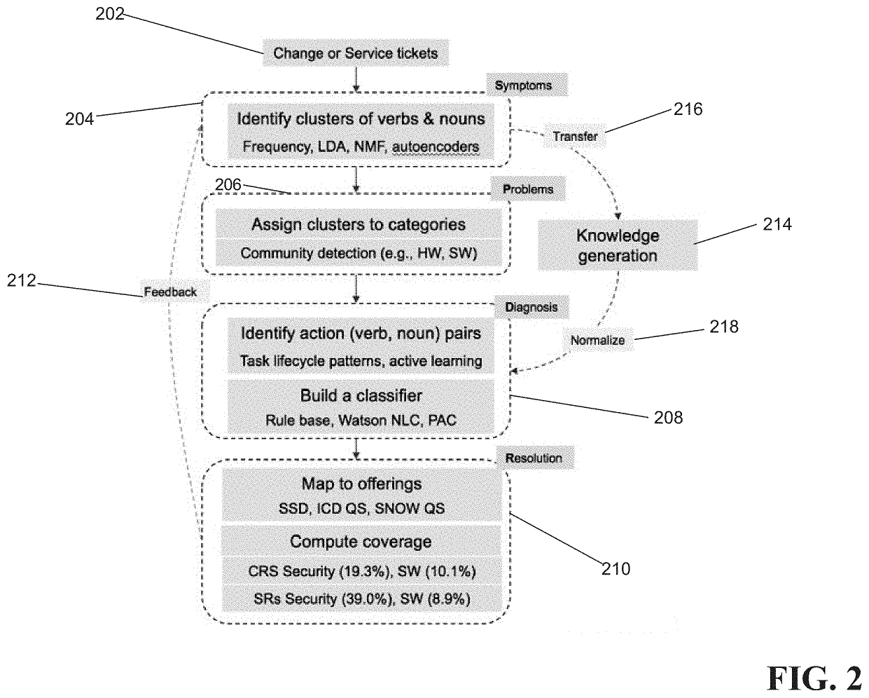

FIG. 2 illustrates the method and data flow along with various connections and feedback loops in accordance with one or more embodiments described herein. Input of change and service tickets (202) are ingested and compiled into a data repository. The tickets are then processed through various approaches (204) such as Frequency, LDA, NMF and autoencoders to create clusters (collection of nouns and verbs extracted from short text descriptions) of data. Act 204 will also store data that will be used for knowledge transfer during the service and change ticket verb and noun syncing exchange. Act 206 assigns clusters to categories (e.g., such as HW, SW, network). Act 208 generates valid noun and verb pairs by analyzing deep parsed graphs generated for each ticket. This ticket will reflect an action and then using this methodology a classifier is built that can be applied to larger data sets. From this point the method matches actions to offerings in act 210 in various catalogs and computes the coverage.

There is a knowledge creation function 214 that transfers data at 216 which is normalized at 218, from acts 204 to 208 to exchange relevant pairs of verbs and nouns to improve coverage for both change and service tickets. The feedback loop 212 returns relevant mappings content back to function 204 that will utilize multiple approaches to generate clusters. The feedback loop inserts re-learning back into the method that can produce new clusters or enhance existing ones based on new mappings and offerings.

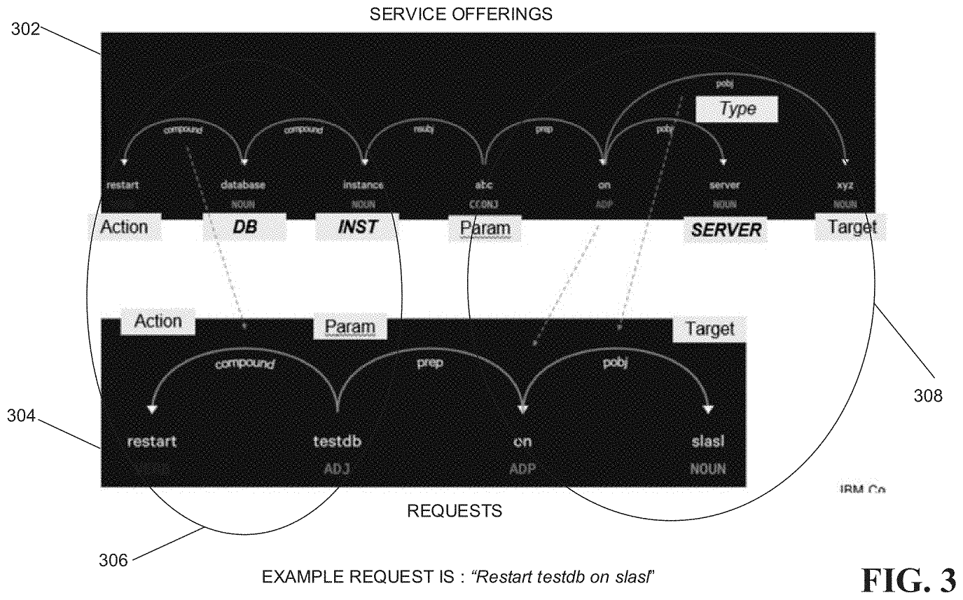

FIG. 3 illustrates action specific Semantic graphs and an example of relationships within the graphs based on the embodiments. In this case, there is an example of a service offerings graph 302 and a requests graph 304. The example request will be identified as “Restart testdb on slasl”. From the semantic graphs 306 it is observed that the request of “restart (which is a verb) testdb (which is a noun)” is matched up to the verb and noun pair of “restart database” in the service offerings. The graph 308 reflects the matching up of request words “on slas” with “instance abc on server xyz” on the service offerings graph.

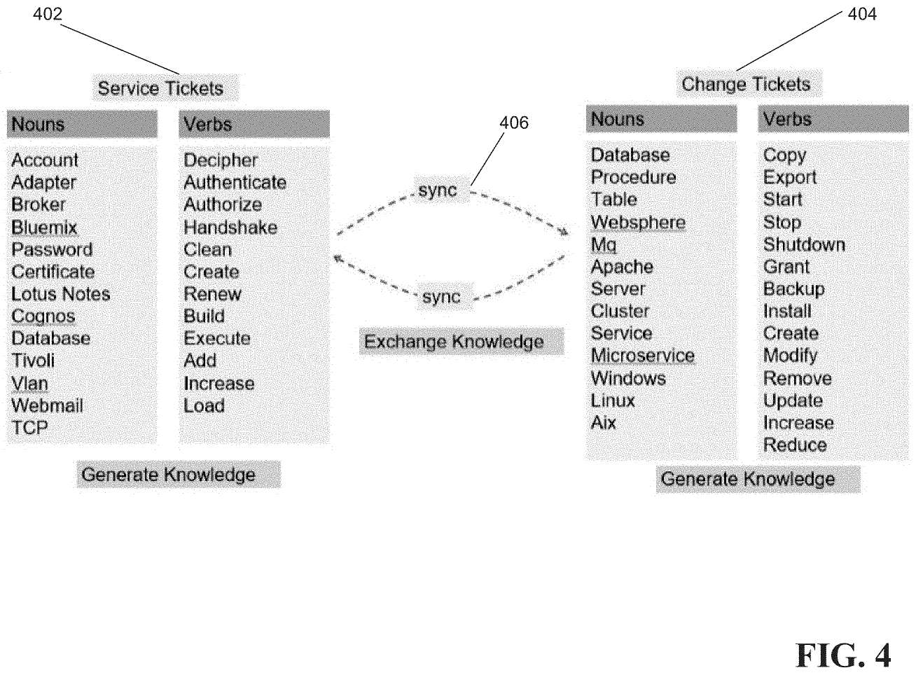

FIG. 4 illustrates basic knowledge transfer between two domains. The data set of nouns and verbs from service tickets are identified at 402. The data set of nouns and verbs from change tickets are identified at 404. A data knowledge sync process 406 identifies correlations between the two sets of data. Any suitable data analysis/correlation technique can be employed, e.g., utilizing correlation coefficients, bivariate correlation analysis, regression analysis, path analysis, canonical correlation analysis, Pearson or product-moment correlation, Spearman Correlation, Kendall Correlation. Relevant pairs of verbs and nouns are exchanged to improve coverage for both change and service tickets. This type of knowledge exchange can be applied to different domains.

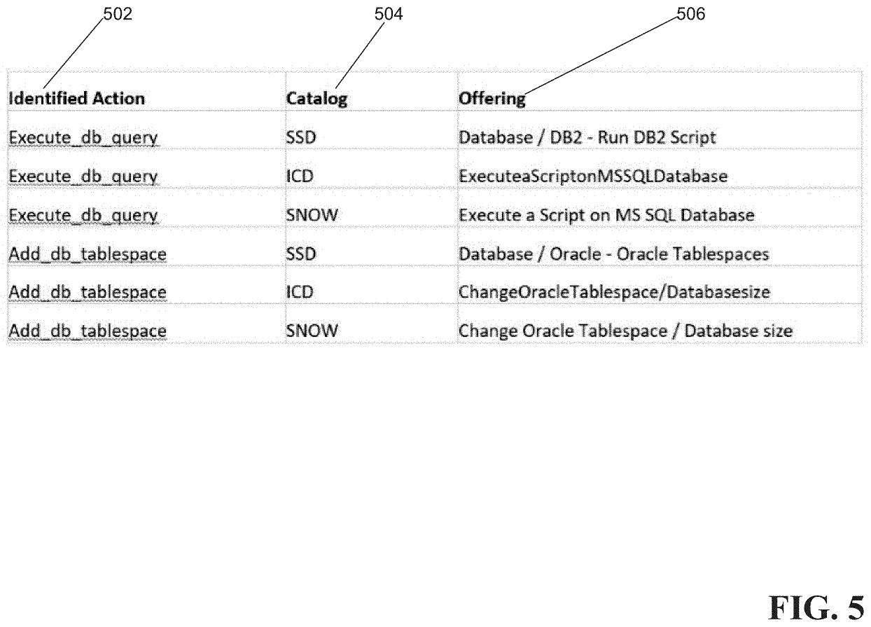

FIG. 5 illustrates mapping of actions to offerings concept in accordance with one or more embodiments described herein. The identified sample actions are listed in column 502, the catalog type in 504 and the various offerings are 506. This is an example of a potential identified action such as the first one listed “Execute_db_query” that is to be mapped to a service offering. It is shown that in catalog SSD, the action can be mapped to offering “Databse/DB2-Run DB2 Script” while for catalog ICD, the same action can be mapped to “ExecuteaScriptonMSSQLDatabase”. The same concept applies to the other actions and offerings.

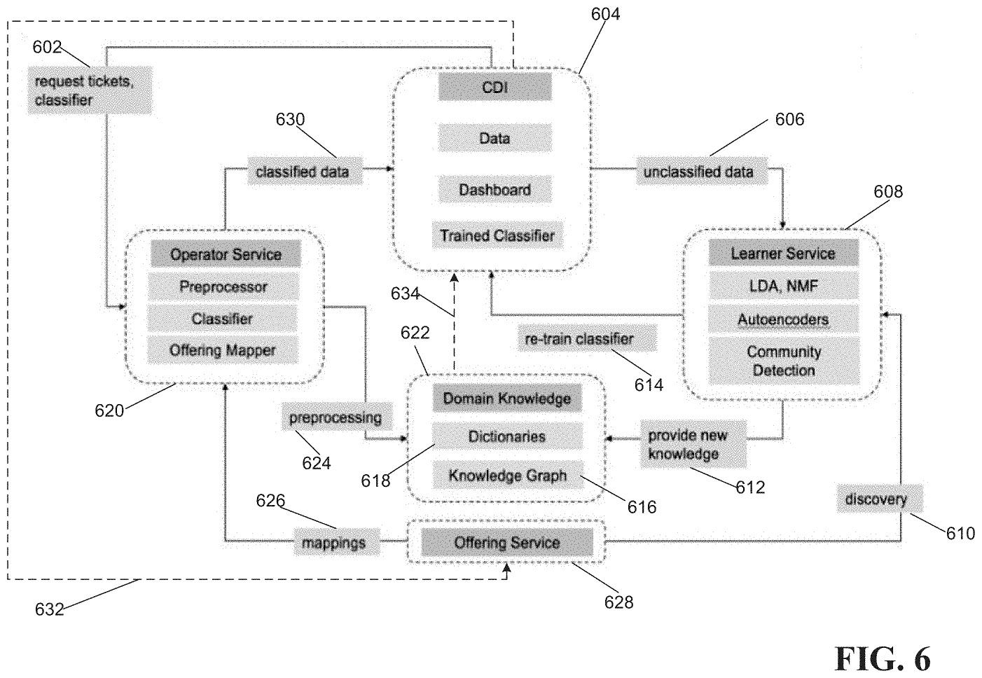

FIG. 6 illustrates an example architecture of one or more embodiments. This is based on the data flow chart depicted in FIG. 2. Initial data are tickets 602 which are inputs into a data lake 604, and an operator service function 620 which will process the current data into classifiers and map the data with offerings, this mapping classified data 630 can be sent to the function 620 which will store the mappings in the data lake 604 where results can be visualized by using a dashboard. This data 632 from 604 can also be sent to an offering service 628. The operator service 620 also executes the preprocessing of data 624 to provide the initial domain knowledge to 622. The domain knowledge service will use dictionaries 618 and knowledge graphs 616 to set up data sets. The offering service 628 also sends the offerings mappings list 626 to 620 to populate the offering mapper. Any new data discovery from the offerings 610 will be sent back to the learner service function 608. For all tickets that do not have coverage, the unclassified data 606 is then piped to the function 608 which is a learner service and will utilize unsupervised approaches (LDA, NMF, Autoencoders) to generate new knowledge based high level clusters and categories. This new knowledge 612 is transferred to the domain knowledge storage function 622 and from there back to 604 as in input 634. There is also data 614 sent back to 604 to re-train the classifier to account for new content.

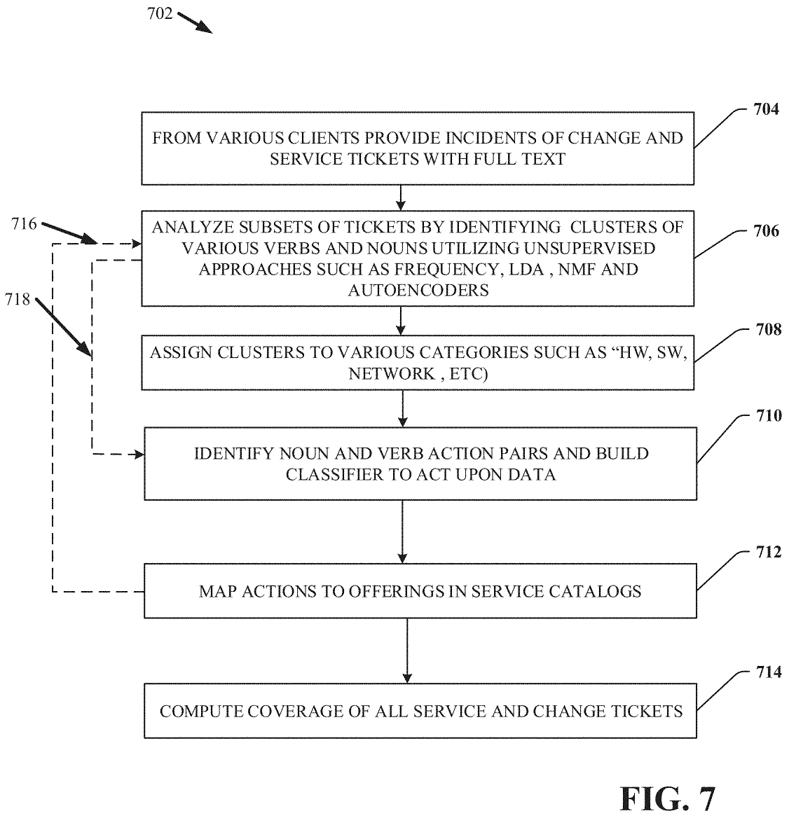

FIG. 7 illustrates the basic method flowchart 702 of the functional steps within the embodiments. Act 704 represents a first step which provides the method with incidents of change and service tickets with full text descriptions. Act 706 can analyze ticket subsets by identifying clusters of various verbs and nouns utilizing unsupervised approaches such as Frequency, LDA, NMF and autoencoders. Act 708 then can assign clusters to various categories such as for example “HW, SW, network . . . ). Act 710 can identify noun and verb action pairs and build a classifier to act upon data. This classifier can then act on larger sets of data as required. Then the method will map actions 712 to offerings in a specific service catalog and conclude with computing the coverage of all service and change tickets at act 714. There is a knowledge transfer path 718 between acts 706 and 710 that facilitates correlating between two data sets, as for example exchanging relevant pairs of nouns and verbs to improve coverage for both service and change tickets. Also, there is a feedback loop 716 that transfers action to offerings mapping data from act 712 back to act 706 to facilitate re-learning and account for new tickets, clusters, categories and offerings.

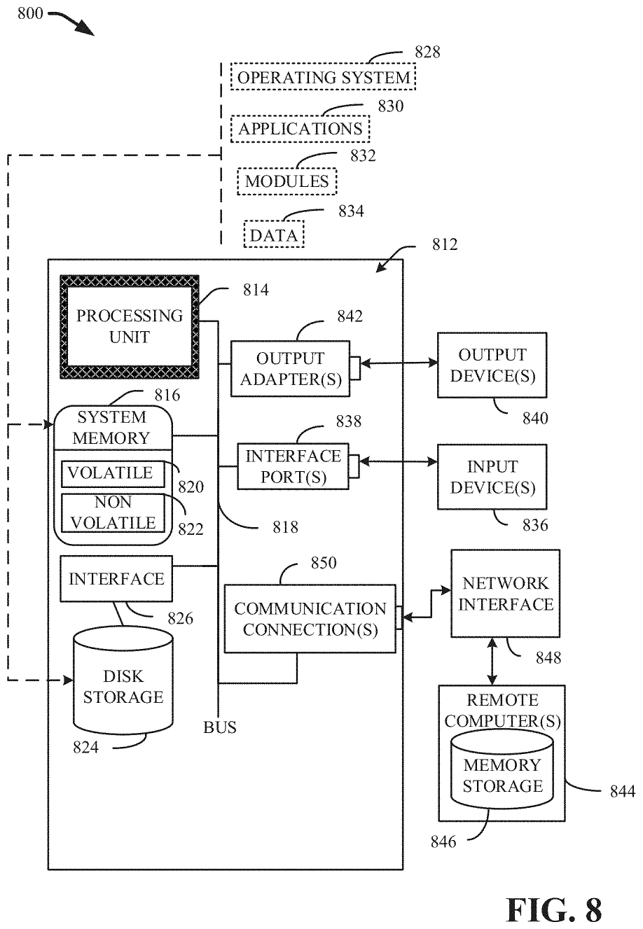

To provide a context for the various aspects of the disclosed subject matter, FIG. 8 as well as the following discussion are intended to provide a general description of a suitable environment in which the various aspects of the disclosed subject matter can be implemented. FIG. 8 illustrates a block diagram of an example, non-limiting operating environment in which one or more embodiments described herein can be facilitated. Repetitive description of like elements employed in other embodiments described herein is omitted for sake of brevity.

A suitable operating environment 800 for implementing various aspects of this disclosure can also include a computer 812. The computer 812 can also include a processing unit 814, a system memory 816, and a system bus 818. The system bus 818 couples system components including, but not limited to, the system memory 816 to the processing unit 814. The processing unit 814 can be any of various available processors. Dual microprocessors and other multiprocessor architectures also can be employed as the processing unit 814. The system bus 818 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Firewire (IEEE 1094), and Small Computer Systems Interface (SCSI). The system memory 816 can also include volatile memory 820 and nonvolatile memory 822. The basic input/output system (BIOS), containing the basic routines to transfer information between elements within the computer 812, such as during start-up, is stored in nonvolatile memory 822. By way of illustration, and not limitation, nonvolatile memory 822 can include read only memory (ROM), programmable ROM (PROM), electrically programmable ROM (EPROM), electrically erasable programmable ROM (EEPROM), flash memory, or nonvolatile random-access memory (RAM) (e.g., ferroelectric RAM (FeRAM). Volatile memory 820 can also include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM.

Computer 812 can also include removable/non-removable, volatile/non-volatile computer storage media. FIG. 8 illustrates, for example, a disk storage 824. Disk storage 824 can also include, but is not limited to, devices like a magnetic disk drive, floppy disk drive, tape drive, Jaz drive, Zip drive, LS-100 drive, flash memory card, or memory stick. The disk storage 824 also can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 824 to the system bus 818, a removable or non-removable interface is typically used, such as interface 826. FIG. 8 also depicts software that acts as an intermediary between users and the basic computer resources described in the suitable operating environment 800. Such software can also include, for example, an operating system 828. Operating system 828, which can be stored on disk storage 824, acts to control and allocate resources of the computer 812. System applications 830 take advantage of the management of resources by operating system 828 through program modules 832 and program data 834, e.g., stored either in system memory 816 or on disk storage 824. It is to be appreciated that this disclosure can be implemented with various operating systems or combinations of operating systems. A user enters commands or information into the computer 812 through input device(s) 836. Input devices 836 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 814 through the system bus 818 via interface port(s) 838. Interface port(s) 838 include, for example, a serial port, a parallel port, a game port, and a universal serial bus (USB). Output device(s) 840 use some of the same type of ports as input device(s) 836. Thus, for example, a USB port can be used to provide input to computer 812, and to output information from computer 812 to an output device 840. Output adapter 842 is provided to illustrate that there are some output devices 840 like monitors, speakers, and printers, among other output devices 840, which require special adapters. The output adapters 842 include, by way of illustration and not limitation, video and sound cards that provide a means of connection between the output device 840 and the system bus 818. It should be noted that other devices and/or systems of devices provide both input and output capabilities such as remote computer(s) 844.

Computer 812 can operate in a networked environment using logical connections to one or more remote computers, such as remote computer(s) 844. The remote computer(s) 844 can be a computer, a server, a router, a network PC, a workstation, a microprocessor-based appliance, a peer device or other common network node and the like, and typically can also include many or all the elements described relative to computer 812. For purposes of brevity, only a memory storage device 846 is illustrated with remote computer(s) 844. Remote computer(s) 844 is logically connected to computer 812 through a network interface 848 and then physically connected via communication connection 850. Network interface 848 encompasses wire and/or wireless communication networks such as local-area networks (LAN), wide-area networks (WAN), cellular networks, etc. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL). Communication connection(s) 850 refers to the hardware/software employed to connect the network interface 848 to the system bus 818. While communication connection 850 is shown for illustrative clarity inside computer 812, it can also be external to computer 812. The hardware/software for connection to the network interface 848 can also include, for exemplary purposes only, internal and external technologies such as, modems including regular telephone grade modems, cable modems and DSL modems, ISDN adapters, and Ethernet cards.

Embodiments of the present invention may be a system, a method, an apparatus and/or a computer program product at any possible technical detail level of integration. The computer program product can include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in one or more computing/processing device receives computer readable program instructions from the network and forwards the computer readable program instructions for storage in a computer readable storage medium within the respective computing/processing device. Computer readable program instructions for carrying out operations of various aspects of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to customize the electronic circuitry, to perform aspects of the present invention.

Aspects of the present invention are described herein with reference to flowchart illustrations and/or block diagrams of methods, apparatus (systems), and computer program products according to embodiments of the invention. It will be understood that one or more blocks of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a manner, such that the computer readable storage medium having instructions stored therein comprises an article of manufacture including instructions which implement aspects of the function/act specified in the flowchart and/or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, one or more blocks in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that one or more block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer and/or computers, those skilled in the art will recognize that this disclosure also can or can be implemented in combination with other program modules. Generally, program modules include routines, programs, components, data structures, etc. that perform particular tasks and/or implement abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments where tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a server computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random-access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems, computer program products, and computer-implemented methods. It is, of course, not possible to describe every conceivable combination of components, products and/or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim. The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising:
a memory that stores computer executable components;
a processor that executes computer executable components stored in the memory, wherein the computer executable components comprise:
an ingestion component that receives data and determines automation opportunities for a service catalog;
a categorization component that determines domain specific clusters and categories of service or change tickets;
a graphing component that generates an action specific semantic graph of service or change ticket offerings; and
a mapping component that maps a valid action to a cataloged service or change ticket.

2. The system of claim 1, wherein the categorization component employs a frequency-based approach that determines frequency of verbs and nouns associated with a subset of the service or change tickets.

3. The system of claim 1, wherein the categorization component employs a topic modeling approach that utilizes Latent Dirichlet allocation and non-negative matrix factorization to analyze a subset of the service or change tickets by generating clusters.

4. The system of claim 1, wherein the received data comprises service or change tickets, and a categorization component employs deep learning to analyze a subset of the service or change tickets by generating clusters.

5. The system of claim 3, wherein the frequency-based approach analyzes a collection of verbs and nouns extracted from text descriptions.

6. The system of claim 3, wherein the frequency-based approach finds relevant verb and noun pairs by analyzing deep parsed graphs generated for each ticket, and wherein the valid verb and noun pairs represent valid actions.

7. The system of claim 1, further comprising a transfer component that applies a transfer learning technique to create knowledge that accounts for ITSM terminologies and category-specific variances.

8. The system of claim 1, wherein the mapping component maps the valid action to an offering to compute coverage over existing catalogs.

9. The system of claim 1, wherein the graphing component matched a semantic graph structure of a request to an offering graph based on features, wherein the features include: distance, weight and type.

10. The system of claim 1, wherein the mapping component utilizes semantic relation of offering descriptions and keywords to facilitate pattern-based matching.

11. A computer-implemented method, comprising:
receiving, by a device operatively coupled to a processor, data and determining automation opportunities for a service catalog;
determining, by the device, domain specific clusters and categories of service or change tickets;
generating, by the device, an action specific semantic graph of service or change ticket offerings; and
mapping, by the device, a valid action to a cataloged service or change ticket.

12. The computer-implemented method of claim 11, further comprising:
employing, by the device, a frequency-based approach that determines frequency of verbs and nouns associated with a subset of the service or change tickets.

13. The computer-implemented method of claim 11, further comprising:
employing, by the device, a topic modeling approach that utilizes Latent Dirichlet allocation and non-negative matrix factorization to analyze a subset of the service or change tickets by generating clusters.

14. The computer-implemented method of claim 11, further comprising:
employing, by the device, deep learning to analyze that received data which comprises service or change tickets, and analyzing a subset of the service or change tickets by generating clusters.

15. The computer-implemented method of claim 12, further comprising:
generating, by the device, clusters that are a collection of verbs and nouns extracted from text descriptions.

16. The computer-implemented method of claim 12, further comprising:
finding, by the device, finds relevant verb and noun pairs by analyzing deep parsed graphs generated for each ticket, and wherein the valid verb and noun pairs represent valid actions.

17. The computer-implemented method of claim 11, further comprising:
applying, by the device, a transfer learning technique to create knowledge that accounts for ITSM terminologies and category-specific variances.

18. The computer-implemented method of claim 11, further comprising:
mapping, by the device, the valid action to an offering to compute coverage for each offering SSD, ICD, SNOW.

19. The computer-implemented method of claim 11, further comprising:
generating, by the device, verb-noun and semantic graph relations by deep parsing standardized service offering descriptions.

20. A computer program product comprising a computer readable storage medium having program instructions embodied therewith, the program instructions executable by processor to cause the processor to:
receive service or change tickets and determines automation opportunities for a service catalog;
determine domain specific clusters and categories of the service or change tickets;
generate an action specific semantic graph of service or change ticket offerings; and
map a valid action to a categorized service or change ticket.
